(19) United States
(12) Patent Application Publication
(10) Pub. No.: US 2025/0353070 A1
(43) Pub. Date: Nov. 20, 2025

(54) TWIST CORRECTION DEVICE AND TWIST CORRECTION METHOD

(71) Applicant: yazaki Corporation, Tokyo (JP)

(72) Inventors: Kousuke MASUDA, Makinohara-shi (JP); Yasuto YAMAUCHI, Makinohara-shi (JP)

(73) Assignee: yazaki Corporation, Tokyo (JP)

(21) Appl. No.: 19/177,914

(22) Filed: Apr. 14, 2025

(30) Foreign Application Priority Data
May 17, 2024 (JP) 2024-080896

(51) Int. Cl. B21F 1/02; H02G 1/12

(52) U.S. Cl. CPC B21F 1/02; H02G 1/1292

(57) ABSTRACT

A twist correction device includes an untwisting mechanism and a controller, the untwisting mechanism being configured to grip a multi-core twisted wire by means of a pair of gripping elements, wherein the pair of gripping elements is configured to slide together toward a tip side of the multi-core twisted wire while performing a relative stroke position offset movement of the pair of gripping elements in a direction of untwisting for untwisting the multi-core twisted wire, wherein when the pair of gripping elements is positioned on an exposure side end side of the multi-core twisted wire, the controller is configured to perform operation control with a smaller gripping force in a twist gripping direction as well as a smaller operation force and a smaller position offset amount for the stroke position offset movement than when the pair of gripping elements is positioned on the tip side.

### BACKGROUND OF THE INVENTION

### Technical Field

The present invention relates to a twist correction device and a twist correction method for untwisting a twisted wire.

### Background Art

In recent years, the demand for high-speed communication cables is expected to be increased, and many of these high-speed communication cables include one or more twisted wires. For applying terminal processing to a twisted wire, such as terminal connection, it is necessary to correct twist at an end of the twisted wire and to untwist it. Conventionally, a device for correcting such twist (see e.g. Patent Document 1). The twist correction device as described in Patent Document 1 is configured to untwist a twisted wire e.g. by sliding on it under pressure from a root side for untwisting to a tip side of the twisted wire, and/or by gripping an end of the twisted wire and then rotating the twisted wire in a direction opposite to a twist direction of the twisted wire.

### CITATION LIST

### Patent Literature

Patent Document 1: JP 2018-185983 A

### SUMMARY OF THE INVENTION

In the above-described twist correction device, the twisted wire tends to be subject to load on the root side during untwisting. In the case where such load is excessively applied to the root side, this may impart burden for the twisted wire in terms of strength. Therefore, this load on the root side during untwisting is not desired.

Therefore, the present invention is focused on the above-described problem, and an objective of the present invention is to provide a twist correction device and a twist correction method which enable a twisted wire to be untwisted while suppressing a load on a root side of the twisted wire for untwisting.

In order to achieve this objective, a twist correction device includes: an electric wire holding section configured to hold a twisted wire at a location of the twisted wire which is spaced further away from a tip of the twisted wire on one end side than a root for untwisting the twisted wire, the root being spaced from the tip by a predetermined distance; an untwisting mechanism including a pair of gripping elements configured to grip the twisted wire between the root and the tip while the twisted wire is held by the electric wire holding section, wherein the pair of gripping elements is configured to: grip the twisted wire in a twist gripping direction intersecting a direction of extension of the twisted wire; and to slide together from a root side to a tip side of the twisted wire while performing a relative stroke position offset movement of the pair of gripping elements in a direction of untwisting for untwisting the twisted wire, the direction of untwisting intersecting both of the direction of extension and the twist gripping direction; and a controller configured to perform operation control of the untwisting mechanism, wherein when the pair of gripping elements is positioned on the root side, the controller is configured to perform the operation control to operate the pair of gripping elements with a smaller gripping force in the twist gripping direction as well as a smaller operation force and a smaller position offset amount for the stroke position offset movement than when the pair of gripping elements is positioned on the tip side.

In order to achieve the above-mentioned objective, a twist correction method includes: an electric wire holding step of holding a twisted wire at a location of the twisted wire which is spaced further away from a tip of the twisted wire on one end side than a root for untwisting the twisted wire, the root being spaced from the tip by a predetermined distance; and an untwisting step of untwisting the twisted wire held in the electric wire holding step by gripping the twisted wire by means of a pair of gripping elements in a twist gripping direction intersecting a direction of extension of the twisted wire and by sliding the pair of gripping elements together from a root side to a tip side of the twisted wire while performing a relative stroke position offset movement of the pair of gripping elements in a direction of untwisting, the direction of untwisting intersecting both of the direction of extension and the twist gripping direction, wherein during the untwisting step, when the pair of gripping elements is positioned on the root side, the twisted wire is untwisted with a smaller gripping force in the twist gripping direction as well as a smaller operation force and a smaller position offset amount for the stroke position offset movement than when the pair of gripping elements is positioned on the tip side.

The above-described twist correction device and twist correction method enable a twisted wire to be untwisted while suppressing a load on a root side of the twisted wire for untwisting.

### BRIEF DESCRIPTION OF THE DRAWINGS

FIG. 1 shows a perspective view of a twist correction device according to a first embodiment;

FIG. 2 shows an enlarged view of a region All as shown in FIG. 1;

FIG. 3 shows a side view of a pair of gripping elements of FIG. 2 as viewed in a direction of an arrow V11 as shown in FIG. 2, together with a multi-core twisted wire to be gripped by the pair of gripping elements;

FIG. 4 shows steps S1 to S4 of a process flow of a twisted wire correction method performed by the twisted wire correction device according to FIGS. 1 to 3;

FIG. 5 shows steps S5 to S8 of the process flow of the twisted wire correction method performed by the twisted wire correction device according to FIGS. 1 to 3;

FIG. 6 shows steps S9 to S10 of the process flow of the twisted wire correction method performed by the twisted wire correction device according to FIGS. 1 to 3; and

FIG. 7 shows a perspective view of a twist correction device according to a second embodiment with regard to a gripping arrangement of a multi-core twisted wire as a difference from the first embodiment.

### DETAILED DESCRIPTION OF THE PREFERRED EMBODIMENTS

Hereinafter, embodiments of a twist correction device and a twist correction method will be described. First, a first embodiment will be described.

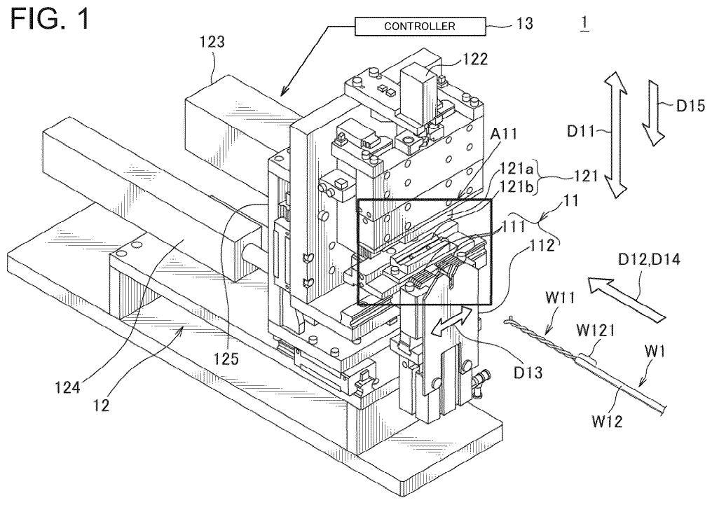

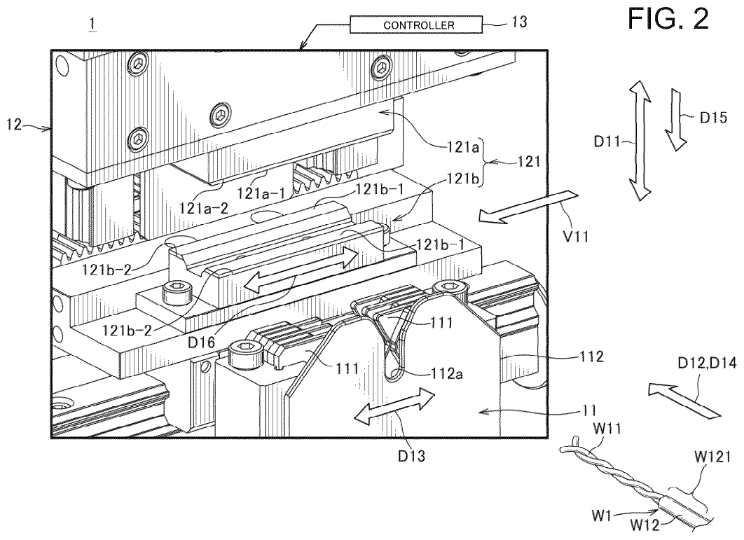

FIG. 1 shows a perspective view of a twist correction device according to a first embodiment, and FIG. 2 shows an enlarged view of a region All as shown in FIG. 1.

The twist correction device 1 according to the present embodiment is configured to receive a multi-core cable W1 including a multi-core (two-core in the present embodiment) twisted wire W11 and to correct twist of the multi-core twisted wire W11 for untwisting it for the purpose of terminal processing, wherein the multi-core twisted wire W11 is exposed at an end. This twist correction device 1 is installed at a predetermined installation location and includes an electric wire holding section 11, an untwisting mechanism 12, and a controller 13.

The electric wire holding section 11 is configured to hold the multi-core cable W1 at an exposure side end W121 of an outermost coating W12 with the multi-core twisted wire W11 being exposed from an outermost coating W12 on one end side, wherein the exposure side end W121 of the outermost coating W12 is facing a portion of the multi-core twisted wire W11 which is exposed. The exposure side end W121 of the outermost coating W12 is at a location spaced further away from a tip of the twisted wire W11 on one end side than a root of the twisted wire W11 for the untwisting, the root being spaced from the tip by a predetermined distance. This electric wire holding section 11 includes a pair of chuck elements 111 and an electric wire guiding plate 112. The pair of chuck elements 111 is configured to grip the multi-core cable W1 in an electric wire chuck direction D13, wherein the electric wire chuck direction D13 intersects both of a vertical direction D11 and a receiving direction D12 for receiving the multi-core cable W1, the vertical direction D11 being defined with respect to the twist correction device 1 in an installed state. The electric wire guiding plate 112 is a plate element positioned on a backward side of the pair of chuck elements 111 in the receiving direction D12, wherein the electric wire guiding plate 112 extends intersecting the receiving direction D12. Furthermore, the electric wire guiding plate 112 has a receiving groove 112a for the multi-core cable W1, wherein the receiving groove 112a is formed downward from an upper end edge in the vertical direction D11. The multi-core cable W1 is inserted through this receiving groove 112a to be introduced between the pair of chuck elements 111 and then gripped at the exposure side end W121 of the outermost coating W12 by the pair of chuck elements 111.

The untwisting mechanism 12 is positioned on a forward side of the electric wire holding section 11 in the receiving direction D12. The untwisting mechanism 12 is a mechanism component configured to untwist the multi-core twisted wire W11 of the multi-core cable W1 held by the electric wire holding section 11. This untwisting mechanism 12 includes a pair of gripping elements 121. The pair of gripping elements 121 includes a first gripping element 121a and a second gripping element 121b, and is configured to grip the multi-core twisted wire W11 of the multi-core cable W11 to place it between them. The untwisting mechanism 12 is configured to cause the pair of gripping elements 121 to grip the multi-core twisted wire W11 in a direction intersecting a direction of extension D14 of the multi-core twisted wire W11 from the exposure side end W121 of the outermost coating W12. In addition, the multi-core twisted wire W11 is gripped between the root for untwisting and the tip of the multi-core twisted wire W11 by the pair of gripping elements 121, wherein the root is located in the vicinity of the exposure side end W121 of the outermost coating W12. According to the present embodiment, the direction of extension D14 of the multi-core twisted wire W11 of the multi-core cable W1 held by the electric wire holding section 11 substantially coincides with the receiving direction D12 of the twist correction device 1 for the multi-core cable W1. Furthermore, the pair of gripping elements 121 is configured to grip the multi-core twisted wire W11 in a direction that substantially coincides with the vertical direction D11 of the twist correction device 1. The first gripping element 121a is positioned on an upper side in the vertical direction D11 while the second gripping element 121b is positioned on a lower side in the vertical direction D11.

With the multi-core twisted wire W11 being gripped by the pair of gripping elements 121, the untwisting mechanism 12 is configured to cause the pair of gripping elements 121 to perform a relative stroke position offset movement in a direction of untwisting D16 for untwisting the twisted wire, the direction of untwisting D16 intersecting both of the direction of extension D14 and the direction of gripping (vertical direction D11). In addition to the stroke position offset movement, the untwisting mechanism 12 is configured to untwist the multi-core twisted wire W11 by sliding the pair of gripping elements 121 together to the tip side from the root side for untwisting. For such various operations, the untwisting mechanism 12 includes a first actuator 122, a second actuator 123, and a third actuator 124, in addition to the pair of gripping elements 121.

The first actuator 122 is an actuation source configured to actuate at least one gripping element of the pair of gripping elements 121 and capable of changing an actuation force for actuating the at least one gripping element. According to the present embodiment, the pair of gripping elements 121 is configured to grip the multi-core twisted wire W11 by moving only the upper first gripping element 121a in the twist gripping direction D15 toward the lower second gripping element 121b. The first actuator 122 is configured to actuate this first gripping element 121a.

The second actuator 123 is an actuation source configured to actuate at least one gripping element of the pair of gripping elements 121 and capable of changing an actuation force and an actuation amount for actuating the at least one gripping element. According to the present embodiment, the pair of gripping elements 121 is configured to perform the stroke position offset movement by moving only the lower second gripping element 121b in the in the direction of untwisting D16. The second actuator 123 is configured to actuate this second gripping element 121b.

The third actuator 124 is an actuation source configured to actuate both gripping elements of the pair of gripping elements 121 together with both gripping elements being combined forward and backward in the direction of extension D14. According to the present embodiment, the untwisting mechanism 12 is configured such that the pair of gripping elements 121, the first actuator 122 and the second actuator 123 are mounted to one frame 125. The third actuator 124 is configured to actuate both gripping elements of the pair of gripping elements 121 together by moving the frame 125 forward and backward in the direction of extension D14.

The controller 13 is a component configured to perform operation control of the untwisting mechanism 12. When the pair of gripping elements 121 is positioned on the root side for untwisting, the controller 13 performs the operation control of the untwisting mechanism 12 to operate the pair of gripping elements 121 with a smaller gripping force in the twist gripping direction D15 as well as a smaller operation force and a smaller position offset amount for the stroke position offset movement than when the pair of gripping elements 121 is positioned on the tip side. Furthermore, the controller 13 performs such operation control by controlling the first actuator 122, the second actuator 123 and the third actuator 124.

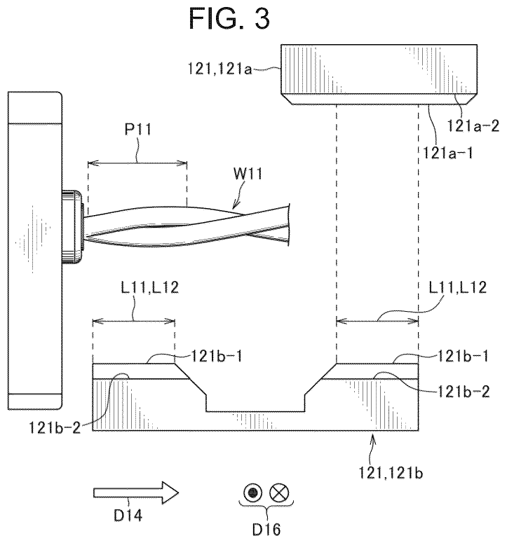

Hereinafter, the pair of gripping elements 121 in the untwisting mechanism 12 will be described in more details with reference to the next FIG. 3.

FIG. 3 shows a side view of a pair of gripping elements of FIG. 2 as viewed in a direction of an arrow V11 as shown in FIG. 2, together with a multi-core twisted wire to be gripped by the pair of gripping elements.

As shown in FIGS. 2 and 3, each of the pair of gripping elements 121 includes one or more flat surfaces 121a-2, 121b-2 facing another of the pair of gripping elements 121 with one or more anti-slip sheets 121a-1, 121b-1 being applied to each flat surface 121a-2, 121b-2. As an example for the anti-slip sheet 121a-1, 121b-1, e.g. a sheet material made of urethane may be used. The pair of gripping elements 121 grips the multi-core twisted wire W11 between the pair of flat surfaces 121a-2 and 121b-2 via the anti-slip sheets 121a-1 and 121b-1. In this case, only one row of flat surface 121a-2 with the anti-slip sheet 121a-1 applied thereto is provided on the upper first gripping element 121a so as to extend in a belt shape in the direction of untwisting D16. On the other hand, multiple rows (two rows in the present embodiment) of flat surface 121b-2 with the anti-slip sheets 121b-1 applied thereto are provided on the lower second gripping element 121b to extend in a narrower belt shape in the direction of untwisting D16 than the first gripping element 121 a and to be arranged in the direction of extension D14. For the untwisting, a flat surface 121b-2 with one anti-slip sheet 121b-1 is selected from the multiple rows of flat surface 121b-2 with the anti-slip sheets 121b-1 applied thereto on the second gripping element 121b to be set for electric wire gripping. Then, the multi-core twisted wire W11 is gripped by means of the flat surface 121a-2 of the first gripping element 121a with the anti-slip sheet 121a-1 and the flat surface 121b-2 of the second gripping element 121b with the one anti-slip sheet 121b-1 which has been set for electric wire gripping. In this case, the selection for electric wire gripping from the flat surfaces 121a-2 and 121b-2 is made by a maintenance operator depending on e.g. a degree of wear of the anti-slip sheets 121b-1 starting from an anti-slip sheet 121b-1 on the forward side in the direction of extension D14. Then, a position of the first gripping element 121a is adjusted so that another flat surface 121a-2 is positioned in a position facing the selected flat surface 121b-2, whereby the flat surface 121b-2 with the anti-slip sheet 121b-1 is set for electric wire gripping.

Furthermore, a gripping width L11 for gripping the multi-core twisted wire W11 by the pair of flat surfaces 121a-2 and 121b-2 is smaller than or equal to a twist pitch P11 of the multi-core twisted wire W11, the gripping width L11 extending in the direction of extension D14, as shown in FIG. 3. Moreover, an anti-slip sheet 121b-1 on each flat surface 121b-2 of at least one of the pair of gripping elements 121, more specifically the lower second gripping element 121b, is applied in a belt shape with a sheet width L12 corresponding to the gripping width L11 in the direction of untwisting D16.

Next, a twisted wire correction method performed under control by the controller 13 in the twisted wire correction device 1 as described above will be described together with detailed control process in the controller 13.

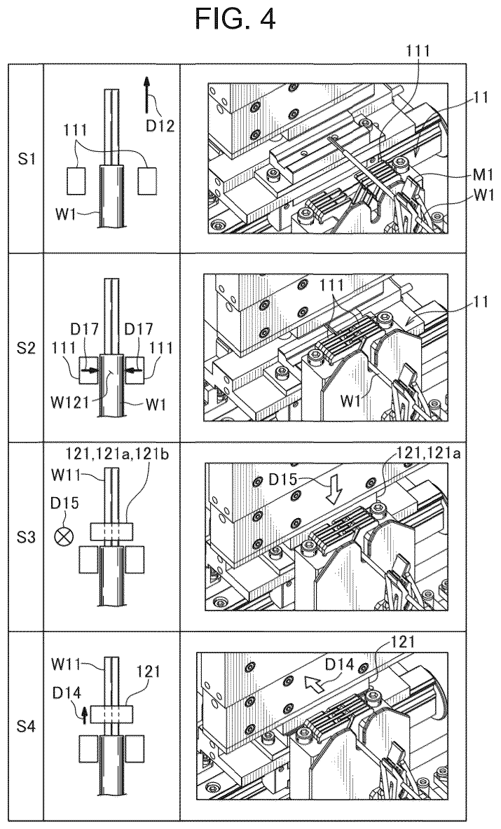

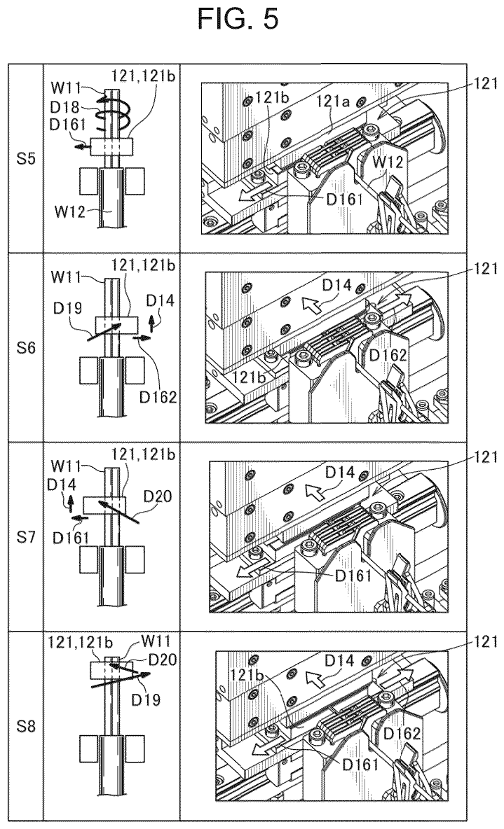

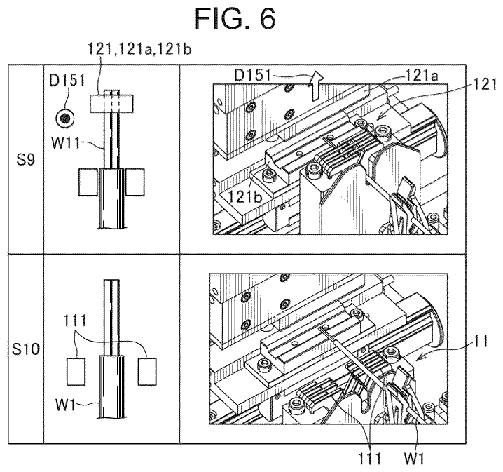

FIG. 4 shows steps S1 to S4 of a process flow of a twisted wire correction method performed by the twisted wire correction device according to FIGS. 1 to 3. FIG. 5 shows steps S5 to S8 of the process flow of the twisted wire correction method performed by the twisted wire correction device according to FIGS. 1 to 3. FIG. 6 shows steps S9 to S10 of the process flow of the twisted wire correction method performed by the twisted wire correction device according to FIGS. 1 to 3. It is to be noted that although FIGS. 4 to 6 depict an untwisted, straight state of a multi-core twisted wire W11 prior to and during untwisting, it is obvious that the multi-core twisted wire W11 is in fact in a twisted state during these phases. Furthermore, in the following description, reference is made to elements as shown in FIGS. 1 to 3, in addition to those designated with reference signs in FIGS. 4 to 6.

At step S1 in FIG. 4, a multi-core cable W1 which has been conveyed in the receiving direction D12 of the twisted wire correction device 1 by means of a conveying clip MI outside the device is inserted into a gripping position in which the multi-core cable W1 is gripped by the pair of chuck elements 111 of the electric wire holding section 11. At this step S1, the electric wire holding section 11 has been retracted downward, and the pair of chuck elements 111 is in an opened state. At next step S2, the electric wire holding section 11 is moved upward, and the pair of chuck elements 111 is closed in the chuck direction D17 so that the multi-core cable W1 is held at a location spaced further away from the tip than the root for untwisting. As described above, the gripping position during this is located at the exposure side end W121 of the outermost coating W12. This step S2 corresponds is an electric wire holding step of holding the multi-core twisted wire W11 at a location of the multi-core twisted wire W11 (exposure side end W121 of the outermost coating W12) which is spaced further away from the tip of the multi-core twisted wire W11 than the root for untwisting the multi-core twisted wire W11, the root being spaced from the tip by a predetermined distance.

At step S3, the upper first gripping element 121a of the pair of gripping elements 121 is moved downward in the twist gripping direction D15 toward the lower second gripping element 121b. As the multi-core twisted wire W11 is placed on the second gripping element 121b, movement of the first gripping element 121a downward results in gripping the multi-core twisted wire W11 in the twist gripping direction D15 along the vertical direction D11.

At next step S4, the controller 13 performs the following operation control prior to untwisting the multi-core twisted wire W11 at step S5 and the following steps: Under the operation control, the pair of gripping elements 121 slides together by a predetermined distance toward the tip side in the direction of extension D14 of the multi-core twisted wire W11. This sliding pulls the multi-core twisted wire W11 in the direction of extension D14 while the multi-core twisted wire W11 is still gripped by the pair of gripping elements 121, whereby tension is applied to the multi-core twisted wire W11, the tension acting in the direction of extension D14. The multi-core twisted wire W11 is extended by applying the tension to be straight in the direction of extension D14, and in this state, the untwisting process at step S5 and the following steps will be applied to the multi-core twisted wire W11.

Step S5 is a first position offset movement performed on the root side for untwisting in the stroke position offset movement of the pair of gripping elements 121 which is performed subsequently, wherein the root side is closest to the exposure side end W121 of the multi-core cable W1. During the first position offset movement at this step S5, the lower second gripping element 121b of the pair of gripping elements 121 is moved in a first direction of untwisting D161, i.e., toward one side in the direction of untwisting D16. The first direction of untwisting D161 during the first position offset movement is a direction of movement corresponding to a twist direction D18 of the multi-core twisted wire W11. In the shown example, the twist direction D18 is a clockwise direction of winding with respect to the outermost coating W12 of the multi-core cable W1.

Accordingly, the first direction of untwisting D161 extends toward left. This movement results in a relative position offset of the second gripping element 121b in the first direction of untwisting D161 while the multi-core twisted wire W11 is still clamped between the second gripping element 121b and the first gripping element 121a. Furthermore, this position offset results in torsion of the multi-core twisted wire W11 in a direction opposite to the twist direction D18 in the gripping position for gripping by the pair of gripping elements 121, whereby untwisting occurs.

At step S6, the pair of gripping elements 121 slides together by a predetermined distance toward the tip side in the direction of extension D14 of the multi-core twisted wire W11 while the second gripping element 121b is moved in a second direction of untwisting D162 opposite (here in a direction toward right) to the first direction of untwisting D161. This movement results in oblique movement of the second gripping element 121b in a first oblique direction D19 (here right oblique direction) toward the tip side in the direction of extension D14 with respect to the multi-core twisted wire W11. The multi-core twisted wire W11 is further untwisted toward the tip side in the direction of extension D14 by the above-mentioned oblique movement of the second gripping element 121b.

At next step S7, the pair of gripping elements 121 slides toward the tip side in the direction of extension D14 while moving the second gripping element 121b in the first direction of untwisting D161. This movement results in oblique movement of the second gripping element 121b in a second oblique direction D20 (here left oblique direction) with respect to the multi-core twisted wire W11. The multi-core twisted wire W11 is still further untwisted toward the tip side in the direction of extension D14 by the above-mentioned oblique movement of the second gripping element 121b.

At step S8, the second gripping element 121b slides to the tip of the multi-core twisted wire W11 while repeating movement in the first direction of untwisting D161 and movement in the second direction of untwisting D162 alternately, i.e. while performing relative stroke position offset movement of the pair of gripping elements 121. This movement results in oblique movement of the second gripping element 121b alternately in the first oblique direction D19 and the second oblique direction D20 with respect to the multi-core twisted wire W11 to move the second gripping element 121b in a zigzag manner to the tip of the multi-core twisted wire W11. The multi-core twisted wire W11 is further untwisted to the tip in the direction of extension D14 by the above-mentioned zigzag movement.

The process at steps S5 to S8 is an untwisting step of untwisting the multi-core twisted wire W11 by the untwisting mechanism 12. Here, in this untwisting process, the stroke position offset movement of the pair of gripping elements 121, more specifically the lower second gripping element 121b, performs the following movement under control by the controller 13, as described above: At steps S5 and S6 during which the pair of gripping elements 121 is positioned on the exposure side end W121 side, a gripping force in the twist gripping direction D15 as well as an actuation force and a movement amount applied to the second gripping element 121b are smaller than at steps S7 and S8 during which the pair of gripping elements 121 is positioned on the tip side. This results in a smaller operation force and a smaller position offset amount in the stroke position offset movement of the pair of gripping elements 121 so that during untwisting, load is suppressed which is applied to the root side of the multi-core twisted wire W11.

At step S9 which is initiated after progress of untwisting of the multi-core twisted wire W11 to the tip, the upper first gripping element 121a of the pair of gripping elements 121 is moved away from the lower second gripping element 121b and lifted in a direction of lifting D151 opposite to the twist gripping direction D15. With lifting the first gripping element 121a, gripping the multi-core twisted wire W11 in the twist gripping direction D15 is released.

At subsequent step S10, the pair of chuck elements 111 of the electric wire holding section 11 is opened and moved downward to a retracted position to release holding the multi-core cable W1, wherein the multi-core cable W1 is then removed. With this step S10, the series of processes of the twisted wire correction method is ended which is performed by the twisted wire correction device 1.

In the twist correction device 1 and the twist correction method according to first embodiment described above, the multi-core twisted wire W11 is untwisted by the relative stroke position offset movement of the pair of gripping elements 121 which is gripping the multi-core twisted wire W11, and by sliding the pair of gripping elements 121 toward the tip side in the direction of extension D14. During this untwisting, when the pair of gripping elements 121 is positioned on the root side for untwisting, the operation control of the controller 13 leads to a smaller gripping force on the multi-core twisted wire W11 as well as a smaller operation force and a smaller position offset amount in the stroke position offset movement than when the pair of gripping elements 121 is positioned on the tip side. On the root side of the multi-core twisted wire W11 for untwisting, this operation control results in suppressed load applied to the multi-core twisted wire W11 during untwisting. In other words, the present embodiment enables a multi-core twisted wire W11 to be untwisted while suppressing a load on a root side of the multi-core twisted wire W11 for untwisting.

According to the present embodiment, the untwisting mechanism 12 includes a first actuator 122, a second actuator 123, and a third actuator 124. The first actuator 122 actuates the upper first gripping element 121a in the twist gripping direction D15, and the second actuator 123 actuates the lower second gripping element 121b in the direction of untwisting D16. Furthermore, the third actuator 124 actuates the pair of gripping elements 121 together to slide in the direction of extension D14 of the multi-core twisted wire W11. Further, the controller 13 controls the first actuator 122, the second actuator 123, and the third actuator 124. In this configuration, the first to third actuators 122 to 124 which actuate in the twist gripping direction D15, direction of untwisting D16 and direction of extension D14 are individually controlled by the controller 13. With such individual control of actuators, it is possible to effectively perform operations in these various directions for untwisting by means of the pair of gripping elements 121.

According to the present embodiment, the multi-core twisted wire W11 is gripped by moving only the upper first gripping element 121a in the twist gripping direction D15, wherein the stroke position offset movement is performed by moving only the lower second gripping element 121b in the direction of untwisting D16. In this configuration, two different gripping elements are provided for movement in different directions D15 and D16, namely the first gripping element 121a for movement in the twist gripping direction D15 and the second gripping element 121b for movement in the direction of untwisting D16, which simplifies a structure of the untwisting mechanism 12. This simplicity of the structure allows assemblability for assembling the device and/or maintainability after completion of the device to be increased, which may reduce costs for assembling the device and/or maintenance costs of the device.

Furthermore, in the present embodiment, the controller 13 performs the operation control so that the first position offset movement in the stroke position offset movement results in movement of the lower second gripping element 121b in the direction of movement corresponding to the twist direction D18 of the multi-core twisted wire W11. In this configuration, the multi-core twisted wire W11 is twisted in a direction opposite to the twist direction D18 by the first position offset movement which results in movement of the gripping elements 121 in the direction of movement corresponding to the twist direction D18, which facilitates untwisting the multi-core twisted wire W11.

Moreover, according to the present embodiment, controller 13 performs the operation control to apply tension to the multi-core twisted wire W11 by sliding the pair of gripping elements 121 to the tip side in the direction of extension D14 prior to untwisting the multi-core twisted wire W11, the tension acting in the direction of extension D14. In this configuration, the multi-core twisted wire W11 is untwisted with the multi-core twisted wire W11 being tensed in the direction of extension D14 to be straight, which facilitates untwisting the multi-core twisted wire W11.

Furthermore, according to the present embodiment, the pair of gripping elements 121 grips the multi-core twisted wire W11 between the pair of flat surfaces 121a-2 and 121b-2 via the anti-slip sheets 121a-1 and 121b-1, the pair of flat surfaces 121a-2 and 121b-2 facing each other. This configuration enables the multi-core twisted wire W11 to be untwisted by effectively moving individual electric wires and by thus loosening the multi-core twisted wire W11 due to friction with the anti-slip sheets 121a-1 and 121b-1.

Furthermore, the gripping width L11 for gripping the twisted wire W11 by the pair of flat surfaces 121a-2 and 121b-2 according to the present embodiment is smaller than or equal to the twist pitch P11 of the twisted wire W11. In addition, the anti-slip sheets 121a-1, 121b-1 are applied in a belt shape with the sheet width L12 corresponding to the gripping width L11. In this configuration, it is possible to effectively untwist the multi-core twisted wire W11 by applying a force to the multi-core twisted wire W11 within a range of the gripping width L11 smaller than or equal to the twist pitch P11 which facilitates the untwisting.

In addition, according to the present embodiment, only one row of flat surface 121a-2 with the anti-slip sheet 121a-1 applied to thereto is provided on the first gripping element 121a of the pair of gripping elements 121. Additionally, multiple rows (two rows) of flat surface 121b-2 with anti-slip sheets 121b-1 are provided on the second gripping element 121b. For untwisting, the multi-core twisted wire W11 is gripped between the flat surface 121a-2 with the anti-slip sheet 121a-1 on the first gripping element 121a and a selected flat surface 121b-2 with one anti-slip sheet 121b-1 on the second gripping element 121b. This configuration enables the untwisting process to be performed while changing the flat surfaces 121b-2 with the anti-slip sheets 121b-1 on the second gripping element 121b for use in gripping the multi-core twisted wire W11 as appropriate, wherein the flat surfaces 121b-2 are changed depending on a degree of wear of the anti-slip sheets 121b-1. The description of the first embodiment is ended here, and hereinafter, a second embodiment will be described. This second embodiment differs from the first embodiment in features for gripping the multi-core twisted wire W11. On the other hand, an overview of the device as well as a twist correction method performed in the device are same as or similar to those of the first embodiment. The following description is focused on differences of the second embodiment from the first embodiment, wherein description of part of the device overview and/or the twist correction method will be omitted which are same as or similar to those of the first embodiment.

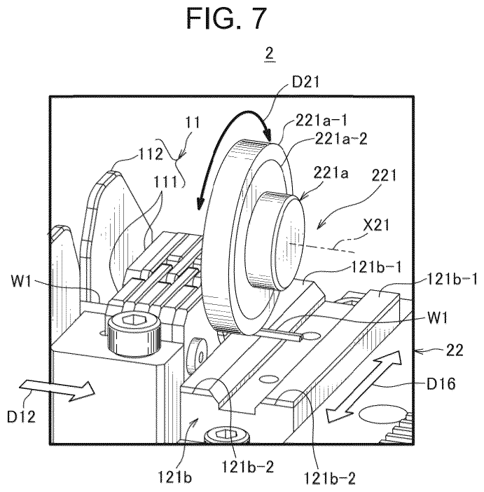

FIG. 7 shows a perspective view of a twist correction device according to a second embodiment with regard to a gripping arrangement of a multi-core twisted wire as a difference from the first embodiment. In this FIG. 7, elements which are same as or similar to those of the first embodiment shown in FIGS. 1 to 6 are designated with same reference signs as FIGS. 1 to 6, wherein repeating description of those elements will be omitted. It is to be noted that FIG. 7 shows a twist correction device 2 with a receiving direction D12 for a multi-core cable W1, wherein the receiving direction D12 is shown as opposite to that e.g. in FIGS. 1 and/or 2 in a right-left direction. Namely, FIG. 7 shows an electric wire holding section 11 including a pair of chuck elements 111 and an electric wire guiding plate 112 on the left hand, and a pair of gripping elements 221 of an untwisting mechanism 22 on the right hand.

Similarly to the first embodiment, the twist correction device 2 according to the present embodiment is provided such that a lower part of the pair of gripping elements 221 includes a second gripping element 121b with multiple rows (two rows) of flat surface 121b-2, wherein anti-slip sheets 121b-1 are applied to the flat surfaces 121b-2. On the other hand, an upper first gripping element 221a of the pair of gripping elements 221 is configured as a roller element which is rotatable around an axis of rotation X21 and includes an annular anti-slip sheet 221a-1 applied on a circumferential surface 221a-2 of the roller element, the axis of rotation X21 extending orthogonally to the direction of untwisting D16. The pair of gripping elements 221 grips the multi-core twisted wire W11 by means of the circumferential surface 221a-2 of the roller element as the first gripping element 221a with the annular anti-slip sheet 221a-1 applied to the circumferential surface 221a-2 and by means of the flat surface 121b-2 of the second gripping element 121b with the anti-slip sheet 121b-1 attached to the flat surface 121b-2. Furthermore, during stroke position offset movement for untwisting, i.e., during stroke movement of the first gripping element 221a in the direction of untwisting D16, the roller element as the first gripping element 221a rolls on the flat surface 121b-2 while being rotated in a direction of rotation D21 around the axis of rotation X21.

Of course, the second embodiment as described above enables untwisting to be performed while suppressing load on the root side of the multi-core twisted wire W11 for exposure, similarly to the first embodiment.

Furthermore, according to the present embodiment, the upper first gripping element 221a is configured as a roller element with the annular anti-slip sheet 221a-1 applied on the circumferential surface 221a-2 of the roller element, wherein during stroke position offset movement, the roller element rolls on the lower second gripping element 121b. In this configuration, contact of the first gripping element 221a as the roller element with the second gripping element 121b provides rolling contact of the annular anti-slip sheet 221a-1 of the first gripping element 221a with the anti-slip sheet 121b-1 of the second gripping element 121b. Such rolling contact enables friction between the two elements to be suppressed, and thus, wear of the individual anti-slip sheets to be suppressed.

It should be noted that the first and second embodiments described above merely show representative forms of a twist correction device and a twist correction method. The twist correction device and the twist correction device method are not limited to the above-described embodiments, but may be implemented in various modifications.

As an example of the twist correction device, the above first and second embodiments show a twist correction device 1, 2 by way of example which includes the pair of gripping elements 121, 221 arranged one above another in the vertical direction D11. In such a twist correction device 1, 2, the multi-core twisted wire W11 is gripped in the twist gripping direction D15 extending along the vertical direction D11. However, the twist correction device is not limited thereto, but the pair of gripping elements may be e.g. arranged adjacent to each other in a horizontal direction, wherein the pair of gripping elements is configured to grip the multi-core twisted wire e.g. in a twist gripping direction extending along the horizontal direction. In what direction the pair of gripping elements should be arranged by installing the twist correction device may be selected as appropriate, e.g. depending on a place to use the device.

As an example of the twist correction device, the above first and second embodiments further show a twist correction device 1, 2 by way of example which includes the multi-core cable W1 as an object to be corrected by the twist correction device 1, 2, the multi-core cable W1 including the multi-core twisted wire W11 coated with outermost coating W12, wherein the multi-core twisted wire W11 includes two electric wires twisted together. However, the twist correction device is not limited thereto, but a twisted wire to be corrected by the twist correction device may be a simple twisted wire without e.g. any coating. Furthermore, any specific number of electric wires may be used for forming the twisted wire.

As an example of the untwisting mechanism, the above first and second embodiments further show the untwisting mechanism 12, 22 by way of example which includes the first actuator 122, the second actuator 123, and the third actuator 124, wherein these actuators 122 to 124 are individually controlled by the controller 13. In this example, the first actuator 122 actuates only the first gripping element 121a, 221a, the second actuator 123 actuates only the second gripping element 121b, and the third actuator 124 actuates the pair of gripping elements 121 together. However, the untwisting mechanism is not limited thereto, but any actuation configuration and/or control configuration may be used for the untwisting mechanism. Nevertheless, an actuation configuration and/or control configuration in which the first to third actuators 122 to 124 are individually controlled by the controller 13 may enable operations in various directions for untwisting to be effectively performed by means of the pair of gripping elements 121, as described above.

As an example of the untwisting mechanism, the above first and second embodiments further show the untwisting mechanism 12, 22 by way of example in which only the first gripping element 121a, 221a is moved in the twist gripping direction D15 to grip the multi-core twisted wire W11. The untwisting mechanism 12, 22 is further configured to perform the stroke position offset movement by moving only the second gripping element 121b in the direction of untwisting D16. However, the untwisting mechanism is not limited thereto, but one same element of the pair of gripping elements may be moved in the twist gripping direction as well as in the direction of untwisting. Nevertheless, costs for assembling the device and/or maintenance costs of the device may be reduced by two different gripping elements provided for movement in different directions D15 and D16, namely the first gripping element 121a for movement in the twist gripping direction D15 and the second gripping element 121b for movement in the direction of untwisting D16, as described above.

As an example of the controller, the above first and second embodiments further show the controller 13 by way of example which is configured to perform the operation control in such a way that the first position offset movement results in movement of the second gripping element 121b in a direction of movement corresponding to the twist direction D18 of the multi-core twisted wire W11. However, the controller is not limited thereto, but the first position offset movement may be performed to move the gripping element in a direction of movement which is independent from the twist direction. Nevertheless, controlling the gripping element to be moved in the direction of movement corresponding to the twist direction D18 in the first position offset movement may facilitate untwisting the multi-core twisted wire W11, as described above.

As an example of the controller, the above first and second embodiments further show the controller 13 by way of example which is configured to perform the operation control prior to untwisting to slide the pair of gripping elements 121, 221 in order to apply tension to the multi-core twisted wire W11. However, the controller is not limited thereto, but the controller may be configured to perform the untwisting process of the multi-core twisted wire without applying any such tension. Nevertheless, the untwisting process of the multi-core twisted wire W11 may be facilitated by applying tension prior to untwisting, as described above.

As an example of the pair of gripping elements, the above first embodiment further shows the pair of gripping elements 121 by way of example which is configured to grip the multi-core twisted wire W11 between the pair of flat surfaces 121a-2 and 121b-2 via the anti-slip sheets 121a-1 and 121b-1, the pair of flat surfaces 121a-2 and 121b-2 facing each other. However, the pair of gripping elements is not limited thereto, but may be configured e.g. to grip a multi-core twisted wire by means of a flat surface and a curved surface, as shown in the second embodiment by way of example. Furthermore, the pair of gripping elements is not limited to those with anti-slip sheets applied to surfaces for gripping, but may be configured e.g. to grip a multi-core twisted wire by means of one or more unprocessed surfaces. Furthermore, when anti-slip processing is applied, it is not limited to application of a sheet member such as a urethane sheet, but e.g. a resin material may be applied which has an anti-slip effect. Nevertheless, individual electric wires of the multi-core twisted wire W11 may be effectively moved by gripping it by means of the flat surfaces 121a-2 and 121b-2 with the anti-slip sheets 121a-1 and 121b-1 applied thereto to loosen the multi-core twisted wire W11 in order to perform the untwisting process.

As an example of the pair of gripping elements, the above first embodiment further shows the pair of gripping elements 121 by way of example which has a gripping width L11 for gripping the twisted wire W11 by the pair of flat surfaces 121a-2 and 121b-2, wherein the gripping width L11 is smaller than or equal to the twist pitch P11. Furthermore, for the pair of gripping elements 121, the anti-slip sheets 121a-1 and 121b-1 have a sheet width L12 corresponds to the gripping width L11. However, the pair of gripping elements is not limited thereto, but any gripping width and any sheet width of the anti-slip sheets may be selected. Nevertheless, the gripping width L11 and/or the sheet width L12 smaller than or equal to the twist pitch P11 may achieve effective untwisting of the multi-core twisted wire W11, as described above.

As an example of the pair of gripping elements, the above first and second embodiments further show the pair of gripping elements 121, 221 by way of example which includes the second gripping element 121a with multiple rows (two rows) of flat surface 121b-2 arranged thereon, the anti-slip sheets 121b-1 being applied to the multiple rows (two rows) of flat surface 121b-2. However, the pair of gripping elements is not limited thereto, but only one row of flat surface with an anti-slip sheet may be provided on the second gripping element similarly. Nevertheless, multiple rows (two rows) of flat surface 121b-2 with the anti-slip sheets 121b-1 applied thereto may enable a portion for gripping to be changed as appropriate depending on a degree of wear of the anti-slip sheets 121b-1.

As an example of the pair of gripping elements, the above second embodiment further shows the pair of gripping elements 221 by way of example which includes the first gripping element 221a configured as a roller element with the annular anti-slip sheet 221a-1, wherein during stroke position offset movement, the roller element rolls on the second gripping element 121. However, the pair of gripping elements is not limited thereto, but may have flat surfaces 121b-2 and 121b-2 with anti-slip sheets 121a-1, 121b, as shown by way of example in the first embodiment. For the pair of gripping elements, any specific component and/or geometry may be selected which enables gripping the multi-core twisted wire, regardless of whether an anti-slip sheet is used or not. Nevertheless, wear of each of the anti-slip sheets may be suppressed by using the first gripping element 221a in the form of a roller element, wherein the roller element is capable of rolling on the second gripping element 121.

### REFERENCE SIGNS LIST

1,2 Twist correction device
11 Electric wire holding section
12 Untwisting mechanism
13 Controller
111 Chuck elements
112 Electric wire guiding plate
112a Receiving groove
121, 221 Gripping elements
121a, 221a First gripping elements
121a-1, 121b-1 Anti-slip sheets
121a-2, 121b-2 Flat surfaces
121b Second gripping element
122 First actuator
123 Second actuator
124 Third actuator
125 Frame
221a-1 Annular anti-slip sheets
221a-2 Circumferential surface
D11 Vertical direction
D12 Receiving direction
D13 Electric wire chuck direction
D14 Direction of extension
D15 Twist gripping direction
D16 Direction of untwisting
D17 Chuck direction
D18 Twist direction
D19 First oblique direction
D20 Second oblique direction
D21 Direction of rotation
D151 Direction of lifting
D161 First direction of untwisting
D162 Second direction of untwisting
L11 Gripping width
L12 Sheet width
MI Conveying clip
P11 Twist pitch
W1 Multi-core cable
W11 Multi-core twisted wire
W12 Outermost coating
W121 Exposure side end
X21 Axis of rotation

What is claimed is:

1. A twisted wire correction device, comprising:
an electric wire holding section configured to hold a twisted wire at a location of the twisted wire which is spaced further away from a tip of the twisted wire on one end side than a root for untwisting the twisted wire, the root being spaced from the tip by a predetermined distance;
an untwisting mechanism including a pair of gripping elements configured to grip the twisted wire between the root and the tip while the twisted wire is held by the electric wire holding section,
wherein the pair of gripping elements is configured to:
grip the twisted wire in a twist gripping direction intersecting a direction of extension of the twisted wire; and
to slide together from a root side to a tip side of the twisted wire while performing a relative stroke position offset movement of the pair of gripping elements in a direction of untwisting for untwisting the twisted wire, the direction of untwisting intersecting both of the direction of extension and the twist gripping direction; and
a controller configured to perform operation control of the untwisting mechanism,
wherein when the pair of gripping elements is positioned on the root side, the controller is configured to perform the operation control to operate the pair of gripping elements with a smaller gripping force in the twist gripping direction as well as a smaller operation force and a smaller position offset amount for the stroke position offset movement than when the pair of gripping elements is positioned on the tip side.

2. The twisted wire correction device according to claim 1,
wherein in addition to the pair of gripping elements, the untwisting mechanism includes:
a first actuator configured to actuate at least one gripping element of the pair of gripping elements in the twist gripping direction, the first actuator being capable of changing an actuation force for actuating the at least one gripping element;
a second actuator configured to actuate at least one gripping element of the pair of gripping elements in the direction of untwisting, the second actuator being capable of changing an actuation force and an actuation amount for actuating the at least one gripping element; and
a third actuator configured to actuate both gripping elements of the pair of gripping elements together with both gripping elements being combined forward and backward in the direction of extension,
wherein the controller is configured to control the first actuator, the second actuator and the third actuator as the operation control.

3. The twisted wire correction device according to claim 1
wherein the pair of gripping elements is configured to:
grip the twisted wire by moving only a first gripping element of the pair of gripping elements toward a second gripping element of the pair of gripping elements in the twist gripping direction; and
perform the stroke position offset movement by moving only the second gripping element in the direction of untwisting.

4. The twisted wire correction device according to claim 1,
wherein the controller is configured to perform the operation control in such a way that a first position offset movement performed on the root side in the stroke position offset movement results in movement of at least one gripping element of the pair of gripping elements in a direction of movement corresponding to a twist direction of the twisted wire.

5. The twisted wire correction device according to claim 1,
wherein prior to untwisting the twisted wire, the controller is configured to perform the operation control to apply tension to the twisted wire by sliding the pair of gripping elements together by a predetermined distance toward the tip side, the tension acting in the direction of extension.

6. The twisted wire correction device according to claim 1,
wherein each of the pair of gripping elements includes a flat surface facing another of the pair of gripping elements with an anti-slip sheet being applied to each flat surface, and
wherein the pair of gripping elements is configured to grip the twisted wire between a pair of flat surfaces of the pair of gripping elements via anti-slip sheets of the pair of gripping elements.

7. The twisted wire correction device according to claim 6,
wherein a gripping width for gripping the twisted wire by the pair of flat surfaces is smaller than or equal to a twist pitch of the twisted wire, the gripping width extending in the direction of extension, and
wherein an anti-slip sheet on at least one of the pair of flat surfaces is applied in a belt shape with a sheet width corresponding to the gripping width in the direction of untwisting.

8. The twisted wire correction device according to claim 6,
wherein the pair of gripping elements is configured such that only one row of flat surface with the anti-slip sheet applied thereto is provided on a first gripping element of the pair of gripping elements so as to extend in a belt shape in the direction of untwisting while multiple rows of flat surface with the anti-slip sheets applied thereto are provided on a second gripping element of the pair of gripping elements to extend in a belt shape in the direction of untwisting and to be arranged in the direction of extension, and
wherein for the untwisting, the pair of gripping elements is configured to grip the twisted wire via the flat surface with the anti-slip sheet on the first gripping element and via a flat surface with one anti-slip sheet selected from the multiple rows of flat surface with the anti-slip sheets applied thereto on the second gripping element.

9. The twisted wire correction device according to claim 1,
wherein a first gripping element of the pair of gripping elements is configured as a roller element which is rotatable around an axis of rotation and includes an annular anti-slip sheet applied on a circumferential surface of the roller element, the axis of rotation extending orthogonally to the direction of untwisting,
wherein a second gripping element of the pair of gripping elements has a flat surface with an anti-slip sheet applied thereto,
wherein the pair of gripping elements is configured to grip the twisted wire via the circumferential surface of the roller element as the first gripping element with the annular anti-slip sheet applied to the circumferential surface and via the flat surface of the second gripping element with the anti-slip sheet applied thereto, and
wherein for the stroke position offset movement, the roller element is configured to roll on the flat surface while being rotated around the axis of rotation.

10. A twisted wire correction method comprising:
an electric wire holding step of holding a twisted wire at a location of the twisted wire which is spaced further away from a tip of the twisted wire on one end side than a root for untwisting the twisted wire, the root being spaced from the tip by a predetermined distance; and
an untwisting step of untwisting the twisted wire held in the electric wire holding step by gripping the twisted wire by means of a pair of gripping elements in a twist gripping direction intersecting a direction of extension of the twisted wire and by sliding the pair of gripping elements together from a root side to a tip side of the twisted wire while performing a relative stroke position offset movement of the pair of gripping elements in a direction of untwisting, the direction of untwisting intersecting both of the direction of extension and the twist gripping direction,
wherein during the untwisting step, when the pair of gripping elements is positioned on the root side, the twisted wire is untwisted with a smaller gripping force in the twist gripping direction as well as a smaller operation force and a smaller position offset amount for the stroke position offset movement than when the pair of gripping elements is positioned on the tip side.
